(19) United States
(12) Patent Application Publication
(10) Pub. No.: US 2012/0232818 A1
(43) Pub. Date: Sep. 13, 2012

(54) RELATIVE PHASE DETECTOR, RELATIVE PHASE DETECTING METHOD AND INFORMATION READING DEVICE

(75) Inventor: Tatsutoshi Shioda, Nagaoka-shi (JP)

(73) Assignee: National University Corportion Nagaoka University of Technology, Nagaoka-shi, Niigata (JP)

(21) Appl. No.: 13/262,107

(22) PCT Filed: Mar. 29, 2010
(86) PCT No.: PCT/JP2010/055619

§ 371 Date: Apr. 20, 2012

(30) Foreign Application Priority Data
Mar. 29, 2009 (JP) 2009-080744

(51) Int. Cl. G06F 19/00

(52) U.S. Cl. 702/66

(57) ABSTRACT

It detects the relative phase of two measured signals using two reference signals. The relative phase detector 1 comprises reference signal generator 11, beat signal processor 12 and detecting element 13. As for reference signal generator 11, a frequency interval generates two reference signals which are the same as the frequency interval of the measured signal of two above. The beat signal processor 12 generates two beat signals from the reference signal of two measured signals and two above, and generation does the multiplication signal of these two beat signals. It removes constant decided by detection system from the DC component of the multiplication signal, and detecting element 13 detects the relative phase of two measured signals.

### FIELD OF THE INVENTION

The present invention relates to a relative phase detector, relative phase detecting method and an information reading device which the relative phase detector was applied by using heterodyne technology.

### BACKGROUND ART

An optical heterodyne technology is known conventionally in the field of optical communication. In the optical heterodyne technology, beat lights are generated by interference of two lights of slightly different frequency. The beat lights are converted into the electrical signal by a photodiode. In this next, the necessary information is read by the electrical signal.

That is, it is supposed that one light is a measurement signal Sₛ, in particular that the other light is a reference signal Sᵣ. It is assumed that information was given for a phase and a amplitude of a measurement signal Sₛ. The above information appears to the beat signals generated by signal Sᵣ and signal Sₛ.

The measurement signal is defined in Sₛ, and the reference beam signal is also defined in Sᵣ. These signals are represented by the next equation.

Sₛ=aₛexp{j(ωₛt+φₛ)} (A1)

Sᵣ=aᵣexp{j(ωᵣt+φᵣ)} (A2)

In the equations, the aₛ is amplitude of the signal Sₛ, moreover the aᵣ is amplitude of the signal Sᵣ. In the equations, the ωₛ is frequency of the signal Sₛ, and the ωᵣ is frequency of the signal Sᵣ. In the equations, the ωₛ is a phase of the signal Sₛ, and the φᵣ is a phase of the signal Sᵣ.

An optical power detected by a photodiode is a time average of |Sₛ+Sᵣ|². The time average is represented by the next equation.

(aₛ²+aᵣ²)+2aₛaᵣ cos [(ωₛ−ωᵣ)t+(φₛ−φᵣ)] (A3)

The first term of the equation (A3) is a DC component, and the second term of the equation (A3) is an AC component (optical beat signal).

Thus, as the amplitude aᵣ is known, the magnitude aₛ of the measurement signal is measured when the amplitude (aₛaᵣ) of the optical beat signal is detected. Also, as the phase ωᵣ is known, the phase φₛ of the measurement signal is measured when the phase (φₛ-φᵣ) of the optical beat signal is detected.

### PRIOR ART DOCUMENTS

### A Patent Document

[patent document 1] JP2006-293,257
[patent document 2] JP2001-227,911

### SUMMARY OF THE INVENTION

### Problem to be Solved by the Invention

In late years, a transmission rate in an optical data communication speeds up, and, for example, the communication technology using the optical frequency comb is proposed in various ways (cf. the patent document 1 or 2).

In the prior art, an amount of information that can be transmitted with one channel is 100 G bits/sec at the maximum. It is assumed that transmitting device transmits optical data at a rate of terabit. Even if optical data is transmitted with terabit order in transmitting side, processing rate of a phase detection with electric circuit can not beyond receiving rate in a receive side. Thus, it is not possible to detect a phase of a signal transmitted at rate of terabit substantially. In other words, the optical data communication at terabit rate cannot be implemented in communication technology using optical frequency comb.

An object of the present invention is to provide a relative phase detector which can detect a relative phase of two measurement signals having a predetermined frequency interval using two reference signals at high-speed.

Another object of the present invention is to provide an information reading device which a relative phase detector was applied to.

### Means to Solve the Problem

A time change of a signal which changed on a time axis related to phase spectrum and amplitude spectrum on the frequency axis closely, and the inventor looked at this fact. To calculate the relative phase of two measurement signals, the inventor introduced two reference signals of a frequency difference which was the same as a frequency difference of these measurement signals into the calculating equation. In addition, the inventor performed an idea of generating two beat signals. One beat signal is generated by “lower frequency reference signal and lower frequency measurement signal”. Also, another beat signal is generated by “higher frequency reference signal and higher frequency measurement signal”. And the inventor obtained a conclusion that the relative phase of two measurement signals could be detected by multiplying these beat signals. A relative phase detector, relative phase detecting method and information reading device of the present invention were created based on the above thought process.

The relative phase detector of the present invention is described in (1)-(3).

(1)

A relative phase detector which detects a relative phase of two measurement signals that frequencies are different using two reference signals at high-speed, the relative phase detector comprising:

a reference signal generator generating two reference signals having constant frequency difference to each of two reference signals of measurement signals,

a beat signal processor which generates a beat signal between lower frequency measurement signal and lower frequency reference signal and a beat signal between higher frequency measurement signal and higher frequency reference signal from the two measurement signals and the two reference signals, wherein the two beat signals are generated by the two measurement signals and two reference signals respectively, here after generates a multiplication signal of the sum of the said two beat signals,

a relative phase detector which removes constant decided by detection system from DC component of the multiplication signal and detects a relative phase of two measurement signals.

In the relative phase detector of the present invention, a measurement signal and a reference signal are optical signals, electrical signals or acoustic signals. When a measured signal and a reference signal are optical signals, photo-electric translator which converts an optical signal into an electrical signal in the beat signal processor is possessed. In the case which a measurement signal and a reference signal are optical signals, a photo-electric converter to convert an optical signal into electrical signal is comprised in a beat signal processor.

Also, a measurement signal and a reference signal may be the acoustic signal. In this case, the beat signal processor has a function to convert an acoustic signal into electrical signal, a function to generate beat signals from the electric signal, and a function to multiply two of the beat signals.

(2)

A relative phase detector comprising amplitude detecting element detecting amplitude of the two measurement signals according to claim 1, wherein the relative phase detector removes a constant decided by detection system using one or more detection results of the amplitude detecting element.

(3)

The relative phase detector comprising a signal path length modulator that changes at least one of signal paths length of the reference signal and the measurement signal according to claim 1 or 2, wherein in the case a relative phase between “0-π” [rad] and a relative phase between “π-2π” [rad] are detected as “relative phases in the appearances” by the relative phase detector, one of these “relative phases in the appearance” is identified as “true relative phase”,

a signal path length modulator changes the signal paths length, and the relative phase detector identifies the relative phase that changes in a right direction among two “relative phases in the appearance” as “true relative phase”.

In the present invention, “0-π” can mean “less than n more than 0”.

“π-2π” can mean “less than 2π more than π”. Also, in the present invention, “0-π” can mean “less than π more than 0”. “2π-π” can mean “less than 2π more greatly than π”.

That is, “π” may be included in “0-π”, and “π” may be included in “2π-π”. The change of the signal paths length by the signal path length modulator can be implemented by changing signal paths length mechanically. Also, the change of the signal paths length can be implemented by using technology of electro optics (nonlinear optical effect) or it can be implemented by using technology. A relative phase detecting method of the present invention assumes (4)-(6) subject matter.

(4)

A relative phase detecting method detecting a relative phase of two measurement signals that frequencies are different,

generating two reference signals having constant frequency difference to each of two measurement signals,

generating the multiplication signal of two beat signals from the two the measurement signals and the two reference signals, wherein one beat signal is generated by lower frequency measurement signal and lower frequency reference signal, and the other beat signal is generated by higher frequency measurement signal and higher frequency reference signal,

a decided constant by detection system is removed from DC component of the multiplication signal, a relative phase of two measurement signals is detected.

(5)

A relative phase detecting method according to claim 4 comprising the step to remove a constant decided by detection system, wherein the constant is determined using a detection result of the amplitude of the two measurement signals.

(6)

The relative phase detecting method according to claimed 4 or 5, wherein, in the case a relative phase between “0-π” [rad] and a relative phase between “π-2π”[rad] are detected as “relative phases in the appearances”, one of these “relative phases in the appearance” is identified as “true relative phase”,

a right direction among two “relative phases in the appearance” is as “true relative phase” by changing a signal paths length.

The relative phase detection technology of the present invention can be applied to information reading device reading information included in the original signal. About two measurement signals in a plurality of measurement signals that frequency is different, a process to detect relative phase and relative magnitude is performed, wherein the two measurement signals are included a original signal.

The information reading device of the present invention assumes (7)-(12) subject matter.

(7)

The information reading device that detects a relative phase and amplitude of two measurement signals in a plurality of measurement signals included in an original signal repeatedly while changing two measurement signals, and reads information included in the original signal,

comprising, a reference signal generator generating two reference signals having a constant frequency difference to each of two measurement signals,

a beat signal processor generating a multiplication signal two beat signals, wherein one beat signal is generated by two reference signals that frequency is low and two measurement signals that frequency is low, the other beat signal is generated by two reference signals that frequency is high and two measurement signals that frequency is high,”

an amplitude detecting element detecting amplitudes two measurement signals from two beat signals, wherein one beat signal is “the beat signal generated from measurement signal that frequency is low and reference signal that frequency is low” and “the beat signal generated from measurement signal that frequency is high and reference signal that frequency is high,”

a relative phase detector detecting relative phase of two measurement signals, wherein a constant decided by detection system is removed from the DC component of the multiplication signal,

an information extractor reading information included in the original signal from a plurality of relative phases and a plurality of amplitudes, wherein a relative phase detected by the relative phase detector and the amplitude detected by the amplitude detecting element is stored sequentially.

In the information reading device of the present invention, a measurement signal and a reference signal are usually an optical signal, an electrical signal, an acoustic signal same as the case of the relative phase detector.

(8)

The information reading device as claimed in (7) that a constant decided by detection system is removed using a detection result of the amplitude detector.

(9)

A information reading device as claimed in (7), (8), wherein, when the relative phase detector detects a relative phase between “0-π” [rad] and a relative phase between “π-2π [rad] as “relative phases in the appearances”, it identifies one of these “relative phases in the appearance” as “true relative phase”,

a signal path length modulator changes at least one of the signal path length of the signal path that the reference signal transmits or the signal path length of the signal path that the measurement signal transmits,

when the signal path length is changes by the signal path length modulator,

the relative phase detector identifies the relative phase that changes to a right direction among two “relative phases in the appearance” as “true relative phase”.

(10)

The information reading device that detects a relative phase and amplitude of two measurement signals in a plurality of measurement signals included in an original signal in parallel while changing two measurement signals, and reads information included in the original signal,

comprising,

(a) reference signal generator,

(b) a beat signal processor (a parallel output),

(c) each a plurality of relative phase detection units comprising the relative phase detector,

It is amplitude detecting element

(d) (e) information extractor,

the reference signal generator generates a plurality of reference signals which are the same as the frequency interval of the measurement signal, but the frequency is different with the frequency of the measurement signal,

the beat signal processor generates a plurality of beat signals from a plurality of measurement signals and the pair with a plurality of reference signals.

It can repeat, and the beat signal processor selects two beat signals from these beat signals, and the above beat signal processor generates these multiplication signals, and it is distributed between the relative phase detection unit of plural above.

The amplitude detecting element detects the amplitude of the measurement signal from the amplitude of the beat signal of plural generated above from the pair with the measurement signal and the measurement signal.

The relative phase detector removes constant decided by detection system from the DC component of the multiplication signal with the relative phase detection unit of plural above.

The relative phase of two measurement signals which became basic of the generation of the beat signal of two above is detected,

The information extractor reads information included in the above original signal from the above amplitude detected by the relative phase detected by the relative phase detection unit of plural above and amplitude detecting element.

Note that the information extractor can be assumed an original signal reload department.

In this case, the information reading device of the present invention is used as a signal reshaping device restoring original signal.

(11)

The relative phase detection apparatus according to claim 10 including removing constant decided by detection system using a detection result of the amplitude detector.

(12)

The information reading device according to claim 10-12: wherein, the relative phase detecting element detects relative phase between 0-π [rad] and relative phase between π-2π [rad] as “relative phase in the appearances”, one of these two “relative phase in the appearance” is identified as “true relative phase”,

the signal path length modulator changing at least one of the signal paths length of the signal paths where the signal paths length of the signal paths where the reference signal spreads, the measured signal spread,

when it changed signal paths length by the signal path length modulator, the relative phase detecting element identifies relative phase changing into the right direction in response to the change as “true relative phase” among “the relative phase in the appearance” of two above.

### Effect of the Invention

In a relative phase detector of the present invention, the relative phase of two measurement signals that frequency is different can be measured using two reference signals at high seed. Even if an absolute phase of each measurement signal is unknown, the measurement is accomplished. In an information reading device of the present invention, a process to detect a relative phase and a relative magnitude are carried out about two measurement signals in a plurality of measurement signals. This process is serial processing or parallel processing. Even if the absolute phase of each measurement signal is thereby unknown, an absolute phase and amplitude of the measurement signal are detected. Thus, information included in an original signal is begun to read. Also, in an information reading device of the present invention, reading of an information included in the high-speed signal is possible, too. For example, a high-speed signal beyond a cutoff frequency of a detection device of an information reading device can read information included in the high speed signal without measuring complicated changes of the signal sequentially. In this case, it is necessary to measure a phase spectrum on a frequency axis and amplitude spectrum.

### BRIEF DESCRIPTION OF DRAWINGS

FIG. 1 is a block diagram which shows a basic constitution of a relative phase detector of the present invention.

FIG. 2 is a figure which shows a relationship between a measurement signal and a reference signal in a frequency axis.

FIG. 3 is a flow chart which shows relative phase detecting method of the present invention.

FIG. 4 is a figure which shows a relationship between a normalized DC component of a signal DC and a relative phase component of a signal DC of two beat signals, wherein both components are a multiplication signals of two beat signals.

FIG. 5 is a block diagram showing a constitution of a relative phase detector of the present invention. In this relative phase detector, a signal path length modulator is comprised on behind of a reference signal generator.

FIG. 6 is a block diagram which shows the example which implemented the function that was equal to signal path length modulator by the drive signal of the laser of the reference signal generator.

FIG. 7 is a block diagram which shows a constitution of a relative phase detector of the present invention which provided a signal path length modulator on a measurement signal path.

FIG. 8 (A) is an illustration to determine “true relative phase”. This figure shows a relationship between normalized DC component and a relative phase component (wherein a reference signal path length was changed).

FIG. 8 (B) shows a relationship with normalized DC component and the relative phase component for explanation of the judgments of “true relative phase” (wherein a measurement signal path length was changed).

FIG. 9 is a figure showing the examples of an information reading device which a relative phase detection technology of the present invention was applied to.

FIG. 10 is a figure showing other example of an information reading device which a relative phase detection technology of the present invention was applied to.

### MODE FOR CARRYING OUT INVENTION

One embodiment of a relative phase detector (and relative phase detecting method) is described. Wherein, a measurement signal and a reference signal are optical signals. Note that, in the present specification, an angular frequency ω is merely called “frequency”.

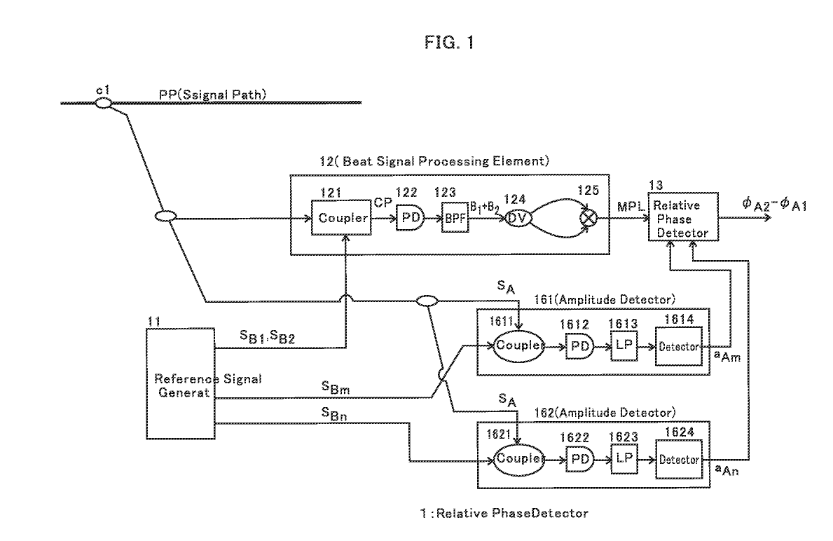

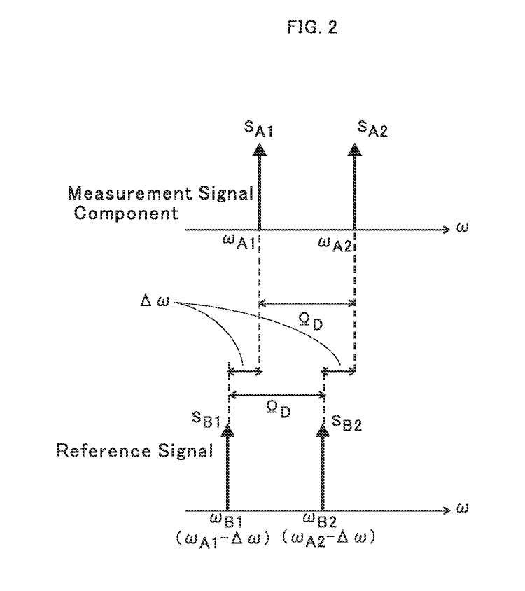

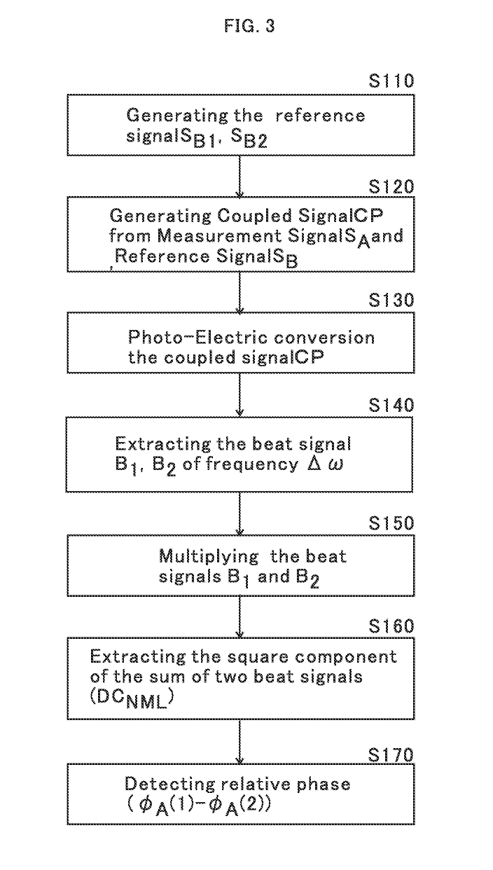

FIG. 1 is a block diagram showing a basic constitution of a relative phase detector of the present invention. FIG. 2 is a figure showing a relationship of a measurement signal (measured light) and a reference signal (a reference beam) in the frequency axis. FIG. 3 is a flow chart showing relative phase detecting method of the present invention. In following explanations, processing step numbers in a flow chart of FIG. 3 are referred appropriately.

In FIG. 1, a relative phase detector 1 detects a relative phase (φ_{A2}-φ_{A1}) of two measurement signals S_{A1}, S_{A2}. Wherein, two measurement signals S_{A1}, S_{A2} are included in an original signal S_{A}, the frequencies of these signals are different.

The relative phase detector 1 comprises of a reference signal generator 11, a beat signal processing element 12, a detecting element 13 and amplitude detecting elements 161,162.

In this embodiment, two measurement signals S_{A1}, S_{A2} are represented as follows.

S_{A1}=a_{A1}exp{j(ω_{A1}t−φ_{A1})} (B1)

S_{A2}=a_{A2}exp{j(ω_{A2}t−φ_{A2})} (B2)

a_{A1}: amplitude of S_{A1},
a_{A2}: amplitude of S_{A2},
ω_{A2}: frequency of S_{A1},
ω_{A2}: frequency of S_{A2},
φ_{A1}: phases of S_{A1},
φ_{A2}: phases of S_{A2}.

Note that the frequencies (ω_{A2}, ω_{A2}) are known, the phase difference (φ_{A2}-φ_{A1}) is unknown. Also, either of φ_{A1} and φ_{A2} may be known. Both φ_{A1} and φ_{A2} are usually unknown.

A discrete spectrum light source (a frequency comb light source) is built in the reference signal generator 11. The reference signal generator 11 generates the reference signals S_{B1}, S_{B2} (S110).

The reference signals S_{B1}, S_{B2} correspond to measurement signals S_{A1}, S_{A2} which are included in an original signal S_{A} as a frequency component.

The reference signals S_{B1}, S_{B2} can be represented as follows.

S_{B1}=a_{B1}exp{j(ω_{B1}t−φ_{B1})} (B3)

S_{B2}=a_{B2}exp{j(ω_{B2}t−φ_{B2})} (B4)

a_{B1}: amplitude of S_{B1},
a_{B2}: amplitude of S_{B2},
ω_{B1}: frequency of S_{B1},
ω_{B2}: frequency of S_{B2},
φ_{B1}: phase of S_{B1},
φ_{B2}: phase of S_{B2}.

A value of the phase φ_{B2} of the reference signal S_{B2} may be different from a value of the phase φ_{B1} of the reference signal S_{B1} (φ_{B1}≠φ_{B2}). The value of the phase φ_{B2} of the reference signal S_{B2} may be the same as a value of the phase φ_{B1} of the reference signal S_{B1} (φ_{B}=φ_{B1}=φ_{B2}). In this embodiment, it is supposed that “φ_{B}=φ_{B1}=φ_{B2}” is formed.

A frequency interval Ω_{D} of the reference signals S_{B1}, S_{B2} is the same as a frequency interval of the measurement signals S_{A1}, S_{A2} as shown in FIG. 2.

A middle value (ω_{B2}−ω_{B1})/2 of the frequency ω_{B2} of the reference signal S_{B1} and the frequency ω_{B2} of the reference signal S_{B2} is set between the frequency ω_{A1} of the measurement signal S_{A1} and the frequency ω_{A2} of the measurement signal S_{A2}.

In this embodiment, a frequency difference between the measurement signal S_{A1} and the reference signal S_{B1} (a frequency difference between the measurement signal S_{A2} and the reference signal S_{B2}) is assumed a value Δω.

That is, it is assumed “Δω=ω_{A1}−ω_{B1}=ω_{A2}−ω_{B2}”.

Between Δω and Ω_{D}, the next relationship is concluded.

|Δω|<|Ω_{D}|/2 (B5)

The reference signals S_{B1}, S_{B2} are represented as follows.

S_{B1}=a_{B1}exp{j(ω_{A1}−Δω)t−φ_{B}} (B6)

S_{B2}=a_{B2}exp{j(ω_{A2}−Δω)t−φ_{B}} (B7)

The beat signal processing element 12 receives the original signal S_{A} through an optical divider cl from a signal path PP. The beat signal processing element 12 generates a beat signal B₁ and a beat signal B₂ from the measurement signals S_{A1}, S_{A2} included in the original signal S_{A} and the reference signals S_{B1}, S_{B2}.

The beat signal B₁ is generated by the measurement signal S_{A1} with low frequency and the reference signal S_{B1} with low frequency.

The beat signal B₂ is generated by the measurement signal S_{A2} with high frequency and the reference signal S_{B2} with high frequency. And the beat signal processing element 12 generates a multiplication signal (MPL) of these two beat signals.

In FIG. 1, the beat signal processing element 12 comprises of a coupler 121, a photodiode (PD) 122, a band pass filter (BPF) 123, and a divider (DV) 124 and a mixer (MX) 125.

The coupler 121 synthesizes the original signal S_{A} and two reference signals S_{B1}, S_{B2}, and it generates a coupled signal CP (S120). And the photodiode (PD) 122 converts the coupled signal CP into an electrical signal (S130).

An output of the photodiode PD122 includes the beat signal B₁ of the measurement signal S_{A1} and the reference signal S_{B1}, and the beat signal B₂ of the measurement signal S_{A2} and the reference signal S_{B2}. Even more particularly, the output of PD122 includes a large number of beats of the original signal S_{A} and the reference signals S_{B1}, S_{B2}. A band pass filter BPF123 extracts two beat signals (B₁ and B₂: frequency Δω) from these beat signals (S140).

A beat signal of frequency Δω generated by the measurement signal S_{A1} and the reference signal S_{B1} is defined as B₁. A beat signal of frequency Δω generated by the measurement signal S_{A2} and the reference signal S_{B2} is defined as B₂. An output of BPF123 includes the following term.

2a_{A1}a_{B1} cos {Δωt+(φ_{A1}−φ_{B})+cnst₁}+2a_{A2}a_{B2} cos Δωt+(φ_{A2}−φ_{B})+cnst₂} (B8)

cnst₁ and cnst₂ are represented in next equations.

cnst₁=(1/c)×[ω_{A1}n_{A1}L_{A}−ω_{B1}n_{B1}L_{B}]

cnst₂=(1/c)×[ω_{A2}n_{A2}L_{A}−ω_{B2}n_{B2}L_{B}])

c: velocity of light

n_{A}: refractive index of the measurement signal path

n_{B}: refractive index of reference signal path

L_{A}: measurement signal path length

L_{B}: reference signal path length

The first term of the equation (B8) is an element of the beat signal B₁. The second term of the equation (B8) is an element of the beat signal B₂. The outputs (or the beat signals) B₁, B₂ of the band pass filter BPF123 are distributed between two passes by the divider (DV) 124. The signals distributed between two passes are multiplied by mixer (MX) 125 (S150).

The multiplication signal (MPL) or output of the mixer (MX) 125 is represented as follows. As described earlier, φ_{B1}=φ_{B2} is formed in the present embodiment.

MPL=(a_{A12}a_{B12}+a_{A22}a_{B22})/2+a_{A1}a_{A2}a_{B2}a_{B1} cos {(φ_{A2}−φ_{A1})+(cnst₂−cnst₁)}+R(Δωt) (B9)

cnst₂−cnst₁ of the equation (B9) is represented in next equation.

cnst₂−cnst₁=(1/c)×[(ω_{A2}n_{A2}−ω_{A1}n_{A1})L_{A}−(ω_{B2}n_{B2}−ω_{B1}n_{B1})L_{B}] (B10)

Also, R (Δωt) in the equation (B9) is a function depending on the product of a beat frequency and time.

The detecting element 13 extracts a DC component of the multiplication signal MPL as described below (cf. equations (B11), (B12)) (S160). A constant to be decided by a detection system is removed from this DC component. The relative phase (φ_{A2}-φ_{A1}) of two measurement signals (S_{A1}, S_{A2}) is thereby detected (S170). The DC component (DC) of the multiplication signal MPL is represented as follows by equation (B9).

DC=(a_{A1}²a_{B1}²+a_{A2}²a_{B2}²)/2/a_{A1}a_{A2}a_{B1}a_{B2} cos {(φ_{A2}−φ_{A1})+(cnst₂−cnst₁)} (B11)

Only a cosine portion is taken out from this equation, and it is normalized.

Thus, a normalized DC component DC_{NML} is represented like an equation (B12).

Note that constant a_{A1}a_{A2}a_{B1}a_{B2} is a predetermined value or a measured value.

DC_{NML}=cos {(φ_{A2}−φ_{A1})+(cnst₂−cnst₁)} (B12)

An element which does not depend on the phase is removed from this normalized DC component DC_{NML}. The element which does not depend on the phase is constant (cnst₂−cnst₁) decided by the detection system. The relative phase Φ_{A}(=(φ_{A2}−φ_{A1})) of two measurement signals (S_{A1}, S_{A2}) is thereby derived. Note that, in the equation (B12), an offset (½) is omitted for.

Note that the constant a_{A1}a_{A2}a_{B1}a_{B2} may be known. In this embodiment, it is detected by the amplitude detecting elements 161 and 162. The amplitude detecting element 161 takes the original signal S_{A} (measurement signal S_{A1}, S_{A2}, . . . , S_{Ak}, . . . S_{AN}), and it takes the reference signal S_{Bm} from the reference signal generator 11.

The amplitude detecting element 161 consists of a coupler 1611, a photodiode (photodiode) 1612, a low pass filter (LPF) 1613 and a detector 1614. The detector 1614 can detect a amplitude a_{Am} of a measurement signal S_{Am} from a beat signal Bₘ. Wherein, the beat signal Bₘ is generated by a reference signal S_{Bm} and a measurement signal S_{Am}. The above similarly, the amplitude detecting element 162 (a comprising coupler 1621, a photodiode PD1622, a low pass filter LPF1623, a detector 1624) can detect an amplitude a_{An} of a measurement signal S_{An} from a beat signal Bₙ. Wherein, the beat signal Bₙ is generated by a reference signal S_{Bn} and a measurement signal S_{An}.

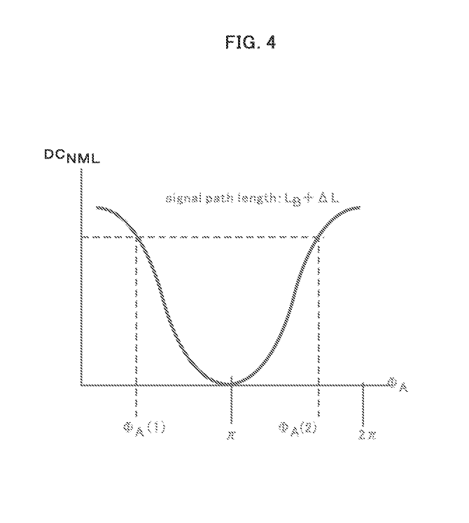

A relationship with the normalized DC component DC_{NML} and the relative phase Φ_{A} are shown in FIG. 4. As shown in FIG. 4, the detecting element 13 usually detects two relative phase Φ_{A} (1), Φ_{A} (2) in an appearance about a certain normalized DC component DC_{NML}. A relative phase Φ_{A}(1) is between (0-π) [rad] and Φ_{A}(2) is between (π-2π) [rad]. One of these two “relative phases in appearance” is “true relative phase”. The measurement signals S_{A1}, S_{A2} may be known whether Φ_{A} is between 0 to π or between π to 2π. In this case, one of the relative phase Φ_{A} (1), Φ_{A} (2) can be determined as “true relative phase”.

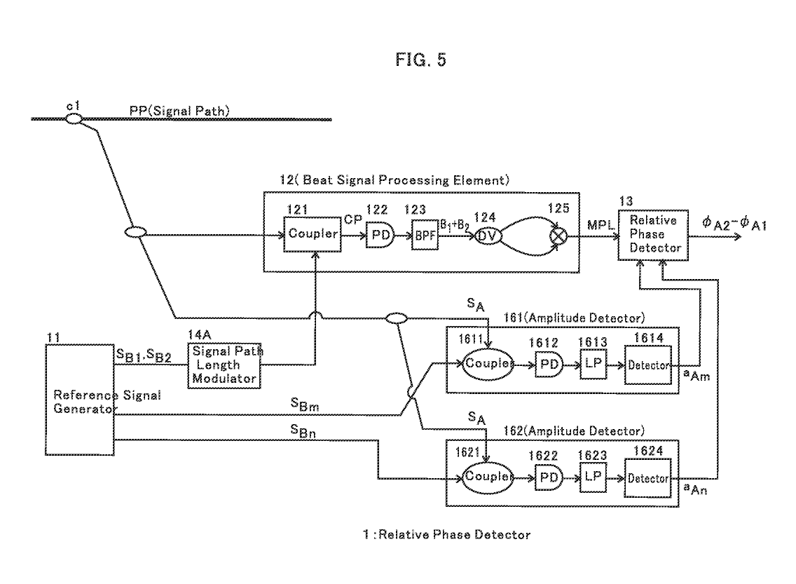

The measurement signal S_{A1}, S_{A2} may be unknown whether Φ_{A} is between (0-π) [rad] or between (π-2π) [rad]. In this case, “true relative phase” can be detected by a relative phase detector. As shown in FIG. 5, a signal path length modulator 14A can be aligned on behind of a reference signal generator 11 (on a signal path where the reference signals S_{B1} and S_{B2} transmit).

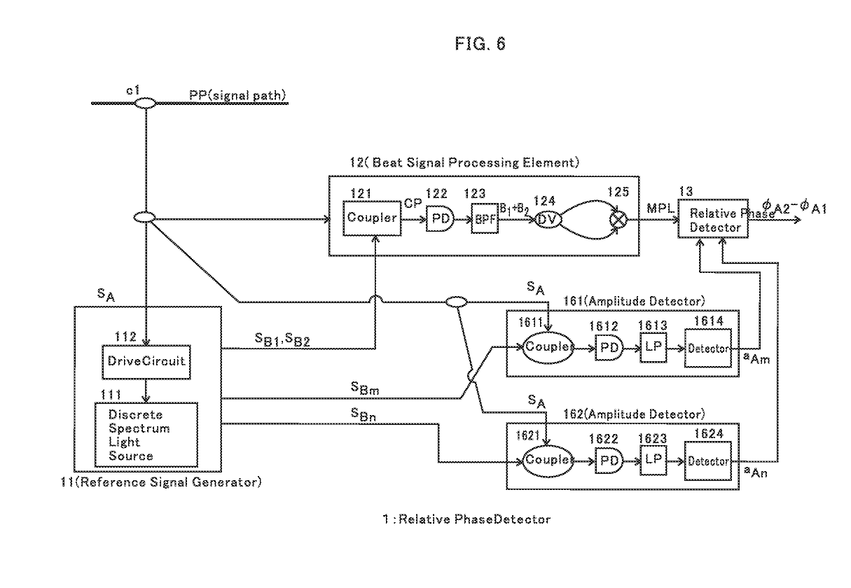

Also, a modulation can be added to a driving signal for a drive circuit 112 of a discrete spectrum light source 111 as shown in FIG. 6. The reference signal generator 11 can thereby have a facility that is equal to the signal path length modulator 14A.

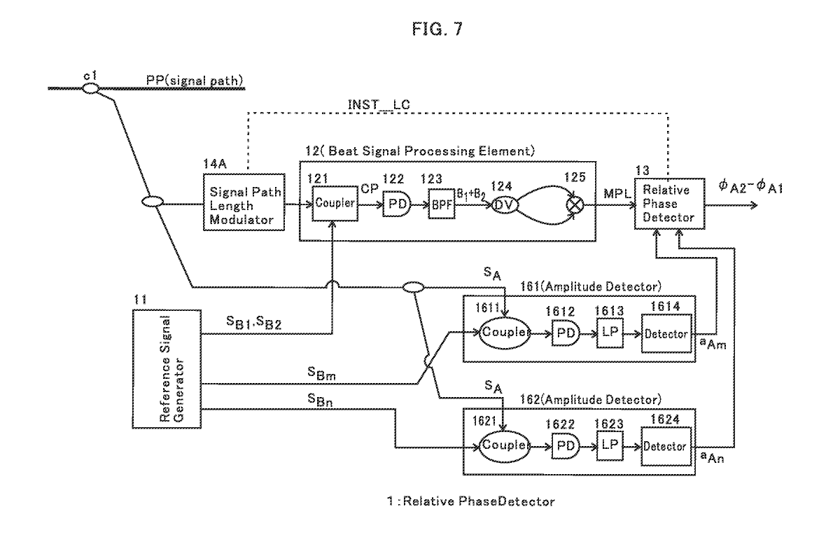

In this case, the reference signal generator 11 can receive the synchronizing signal of the measurement signals (S_{A1}, S_{A2}) from the origin of transmission of the original signal S_{A}. And the reference signal generator 11 can generate a synchronizing signal from a measurement signals (S_{A1}, S_{A2}) directly. Even more particularly, a signal path length modulator 14B can be located on a measurement signal path where the measurement signal S_{A1} or S_{A2} transmits as shown in FIG. 7. In this case, the detecting element 13 can send the distance modulation instruction signal INST_LC to the signal path length modulator 14B.

One of “relative phases in the appearance” Φ_{A} (1), Φ_{A} (2) shown in FIG. 4 can be identified as “true relative phase” by the signal path length modulator 14A of FIG. 5 or the signal path length modulator 14B of FIG. 7. For example, a value of cnst₂-cnst₁ of the equation (B10) becomes smaller if the reference signal path length L_{B} changed longer only micro distance by the signal path length modulator 14A of FIG. 5.

On the contrary, a value of cnst₂-cnst₁ of the equation (B10) becomes larger if the reference signal path length L_{B} changed shorter only micro distance by the signal path length modulator 14A of FIG. 5. Also, a value of cnst₂-cnst₁ of the equation (B10) becomes larger if the reference signal path length L_{A} changed longer only micro distance by the signal path length modulator 14B of FIG. 7. On the contrary, a value of cnst₂-cnst₁ of the equation (B10) becomes smaller if the reference signal path length L_{A} changed shorter only micro distance by the signal path length modulator 14B of FIG. 7.

For example, in the relative phase detector 1 of FIG. 5, the value of DC_{NML} is assumed to be γ. Also, in an appearance, it is supposed that two relative phases Φ_{A}(1), Φ_{A}(2) were detected (cf. FIG. 4).

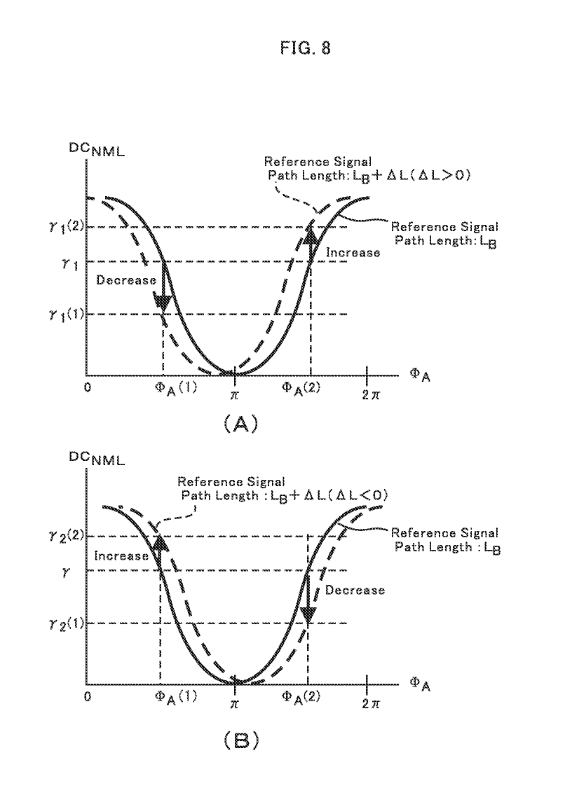

In this case, by the signal path length modulator 14A, the reference signal path length L_{B} can be changed into L_{B}+ΔL (ΔL>0). As shown in FIG. 8 (A), the signal path length characteristic varies from L_{B} (solid line) to L_{B}+ΔL (broken line). If the normalized DC component DC_{NML} decreases to γ(1) then, it can be determined that Φ_{A}(1) is “true relative phase”. If the normalized DC component DC_{NML} increases in γ(2) it can be determined that Φ_{A}(2) is “true relative phase”. Also, by signal path length modulator 14A the reference signal path length L_{B} can be changed into L_{B}+ΔL (ΔL<0). As shown in FIG. 8(A), the signal paths long characteristic varies from L_{B} (a solid line) to L_{B}+ΔL (a broken line).

If the normalized DC component DC_{NML} decreases to γ(1) then, it can be determined that Φ_{A}(2) is “true relative phase”. If the normalized DC component DC_{NML} increases in γ(2) it can be determined that Φ_{A}(1) is “true relative phase”.

As discussed above, in the relative phase detector 1, the processor can calculate only a relative phase with the detecting element 13. And the processor does not be required operation or a calculation about the other processing (processing for the coupler 121, PD122, BPF123, DV124 and MX125). Thus, the detection of the relative phase (or the detection of the phase) can be performed at high speed.

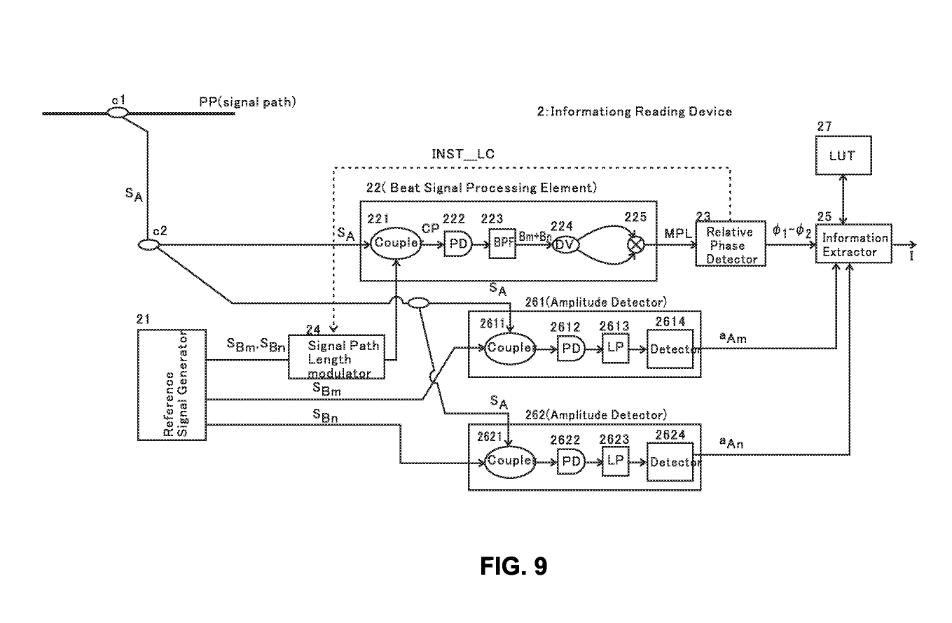

Other example of the information reading device which a relative phase detection technology of the present invention was applied to is described below. In this example, a measurement signal and a reference signal are optical signals. An information reading device 2 works to detect a relative phase and amplitudes about two measurement signals S_{Am}, S_{An} in a plurality of measurement signals S_{A1}, S_{A2}, . . . , S_{Ak}, . . . , S_{AN} as described below in FIG. 9. The measurement signals S_{A1}, S_{A2}, . . . , S_{Ak}, . . . S_{AN} are included in the original signal S_{A} as frequency components. A frequency interval of the measurement signals is Ω_{D}. While changing a combination of the measured signals the above processes (serial processing) are repeated. The information included in the original signal S_{A} are begun to read.

The information reading device 2 consists of a reference signal generator 21, a beat signal processing element 22, a relative phase detecting element 23, an amplitude detecting element 261,262, an information extraction department 25, a look up table LUT27 and a signal path length modulator 24. In this example, an original signal S_{A} (component includes S_{A1}, S_{A2}, . . . , S_{Ak}, . . . S_{AN}) is sent out again and again several times, and the information reading device 2 can receive the same measurement signal several times.

The reference signal generator 21 includes a discrete spectrum light source same as the reference signal generator 11 shown in FIG. 1.

The reference signal generator 21 can select two reference signals sequentially in combination like (S_{B1} and S_{B2}), (S_{B2} and S_{B3}), . . . , (with S_{Bk} S_{B(k+1)}), . . . , (S_{B(N-1)} and S_{BN}). The two measurement signals, (S_{A1} and S_{A2}), (S_{A2} and S_{A3}), . . . , (with S_{Ak} S_{A(k+1)}), . . . , (S_{A(N-1)} and S_{AN}), are detected.

The frequency of S_{Aj} and the frequency of S_{Bj} are different (j=1, 2, 3, . . . , N). However, a value of [S_{B(k-1)}−S_{Bk}] and a value of [S_{A(k-1)}−S_{Ak}] are the same (the value is Ω_{D}).

With a case that a certain measurement signal S_{A(x+1)} is indefinite, the reference signal generator 21 can select the pair of S_{Bx} and S_{B(x+2)}. For example, in a case which there is not a measured signal of frequency ω_{B(x+1)} corresponding to S_{B(x+1)}, the measured signal S_{A(x+1)} is indefinite. In this case, S_{Ax} and S_{A(x+2)} are generated, and the relative phase between S_{Bx} and S_{B(x+2)} is detected.

It can be determined whether measurement signal S_{A(x+1)} is indefinite as follows. At first a relative phase between S_{Ak} and the S_{A(k+1)} is detected. Then, amplitudes a_{Ak}, a_{A(k+1)} are detected. Hereafter, it is determined whether a value of amplitude a_{Ak} or a_{A(k+1)} is 0 in data processing. The amplitude S_{Ak} is indefinite if the value of the amplitude a_{Ak} is zero. The amplitude S_{A(k+1)} is indefinite if the value of the amplitude a_{Ak(k+1)} is zero. In this example, the information reading device 2 receives the original signal S_{A} several times as previously described. Wherein, the original signal S_{A} includes S_{A1}, S_{A2}, . . . , S_{Ak}, . . . , S_{AN}.

Thus, amplitudes a_{Ak}, a_{A(k+1)} are detected, and it is judged whether each of the amplitudes S_{Ak}, S_{A(k+1)} is indefinite. The relative phase is detected if all of amplitudes are not indefinite. The relative phase is detected in next time if any of amplitudes is indefinite. In the time, two measurement signals (except the measurement signals judged to be indefinite) are chosen, and the relative phase is detected with the same manner above.

In this example, an original signal S_{A} may be sent out only one time.

That is, the information reading device 2 may receive the same measurement signal only one time. In this case, a delay circuit is prepared for the relative phase detection system. For example, the delay circuit is prepared to an appropriate part of the beat signal processor 22. The amplitude a_{Ak} of measurement signal S_{Ak} and the amplitude a_{Ak} of measurement signal S_{A(k+1)} can be detected ahead of the detection of the relative phase by comprising as above.

The beat signal processing element 22 generates a multiplication signal MPL_{m/n} from two measurement signals S_{Am}, S_{An} and two reference signals S_{Bm}, S_{Bn}. The multiplication signal MPL_{m/n} is multiplication of the beat signal Bₘ and the beat signal Bₙ. The beat signal Bₘ is generated by the measurement signal S_{Am} and the reference signal S_{Bm}, the beat signal Bₙ is generated by the measurement signal S_{An} and the reference signal S_{Bn}. The beat signal processing element 22 comprises of a coupler 221, PD222, BPF223, DV224 and MX225. These are the same as the coupler 121, PD122, BPF123, DV124 and MX125 in the beat signal processing element 12 shown FIG. 1.

The relative phase detecting element 23 removes the constant (cnstₙ-cnstₘ) from DC component DC_{m/n} of the multiplication signal MPL_{m/n}. Wherein, the constant (cnstₙ-cnstₘ) is decided depending on the detection system.

And the relative phase detecting element 23 detects the relative phase (φ_{An}−φ_{Am}) of two measurement signals S_{Am}, S_{An}.

The relative phase detecting element 23 is the same as detecting element 13 shown in FIG. 1. In this example, the relative phase detecting element 23 detects two “relative phases in the appearance” as described in FIG. 8 (A), (B). The relative phase detecting element 23 can identify one of two “relative phases in the appearance” as “true relative phase” using the signal path length modulator 24.

The amplitude detecting element 261 inputs the original signal S_{A} (measurement signals S_{A1}, S_{A2}, . . . , S_{Ak}, . . . S_{AN}) and inputs the reference signal S_{Bm} from the reference signal generator 21.

The amplitude detecting element 261 consists of a coupler 2611, a photodiode (photodiode) 2612, a low pass filter (LPF) 2613 and a detector 2614. The detector 2614 can detect amplitude a_{Am} of measurement signal S_{Am} from a beat signal Bₘ of the reference signal S_{Bm} and the measurement signal S_{Am}.

The amplitude detecting element 262 takes an original signal S_{A} (measurement signals S_{A1}, S_{A2}, . . . , S_{Ak}, . . . S_{AN}), and the reference signal S_{Bn} is taken from the reference signal generator 21 likewise.

The amplitude detecting element 262 consists of a coupler 2621, PD2622, LPF2623 and detection circuit 2624.

The detecting element 2624 can detect amplitude a_{A}, of measurement signal S_{An} from a beat signal Bₙ of the reference signal S_{Bn} and the measurement signal S_{An}.

Note that, in the above example, the amplitude detecting element 261 detects amplitude a_{Am}, and the amplitude detecting element 262 detects amplitude a_{An}.

As mentioned earlier, in the example, the original signal S_{A} is sent out several times again and again. The information reading device 2 can receive the same measurement signal several times. Thus, the amplitude a_{Am} is detected in a certain time, and the amplitude a_{An} can be detected by the next time.

The relative phase (φ_{An}−φ_{Am}) is detected by the relative phase detecting element 23, and amplitude a_{Am}, a_{An} are detected by amplitude detecting element 26. The information extraction department 25 stores relative phase (φ_{An}−φ_{Am}) and amplitude a_{Am}, a_{An} sequentially. And the information extraction department 25 reads information I that is included in the original signal S_{A} from plurality of relative phases and a plurality of amplitudes.

For example, a phase of a certain measurement signal can be set to zero [rad]. Based on this, a phase of other measurement signals can be established. Therefore, the information extraction department 25 can determine measurement signals S_{Ak} (k=1, 2, . . . , N) from detected phase and amplitude as follows.

S_{Ak}′=a_{Ak}exp{j(ω_{Ak}t+φ_{Ak}′)} (B13)

(k=1, 2, . . . , N)

φ_{Ak}: a phase when the phase of a certain measurement signal was defined to zero (0 [rad]).

S_{Ak}′: a signal when the measurement signal S_{Ak} has this phase.

Therefore, the original signal S_{A} is reproduced by calculating ΣS_{Ak}′ (k:1, 2, 3, . . . , N).

Note that a difference between phase φ_{Ak} and phase φ_{Ak}′ are the same about all k. Thus, ΣS_{Ak}′ is the same as original signal S_{A} substantially.

Also, the information I is comprised of sixteen kinds of original signals when the original signal S_{A} is a packet of four bits. In this case, the information extraction department 25 can store the detected information I in the look up table (LUT) 27.

The detected information I is associated with the relative phase and the amplitude, and look up table (LUT) 27 can store the information I. The information extraction department 25 can thereby detect the information I without calculating ΣS_{Ak}′, if the phase φ_{Ak} of S_{Ak} and the phase φ_{Ak}′ of S_{Ak}′ can be known.

Other example of the information reading device is described below. Wherein, a relative phase detection technology of the present invention is applied to the information reading device.

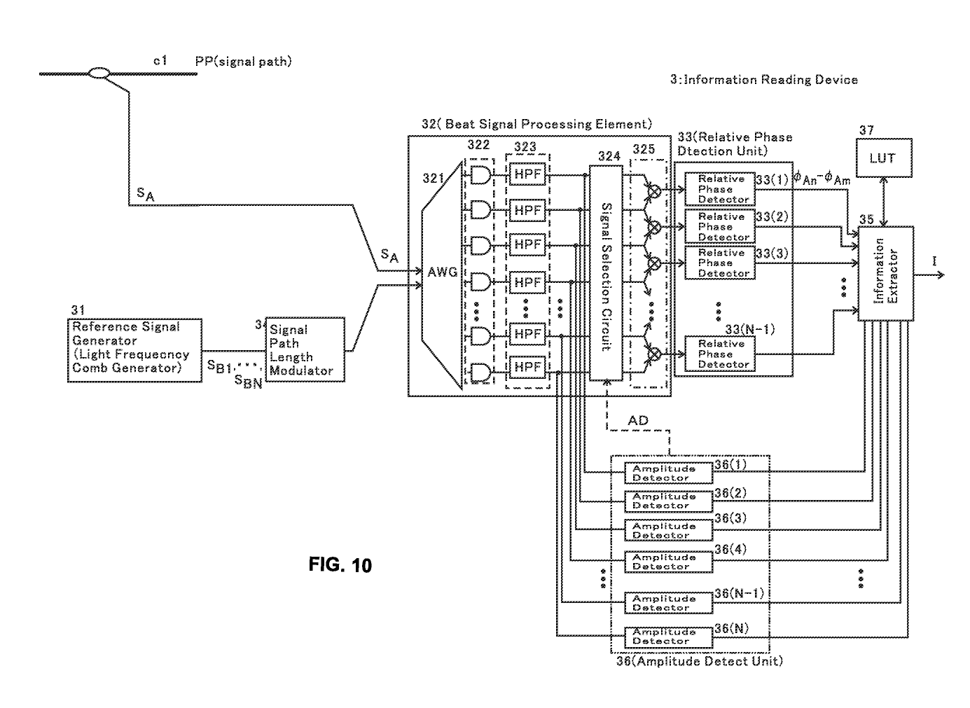

In this particular example, a measurement signal and a reference signal are optical signals. In FIG. 10 an information reading device 3 detects a relative phase and a amplitude between two measured signals S_{An}, S_{A(n+1)}.

Two measured signals (S_{An}, S_{A(n+1)}) are two signals in a plurality of the measured signals (S_{A1}, S_{A2}, . . . , S_{Ak}, . . . S_{AN}).

The frequency interval Ω_{D} of two measured signals next to each other is different. The measurement signals (S_{A1}, S_{A2}, . . . , S_{Ak}, . . . S_{AN}) are the signals which are included in the original signal S_{A} as frequency components. The information reading device 3 performs the above process in parallel (parallel processing is performed). On the occasion of the processing, the combination of the measured signal is changed. The information reading device 3 can thereby read the information included in the original signal S_{A}. Note that, in this example the original signal S_{A} is sent out again and again. Thus, the information reading device 3 can receive the same measurement signal several times.

The information reading device 3 is comprised of a reference signal generator 31, a beat signal processor 32, relative phase detection unit 33 (comprising a plurality of relative phase detector 33(k) (k=1, 2, 3, . . . , N−1)) of (N−1), a signal path length modulator 34, a information extractor 35, an amplitude detecting element 36 and a look up table LUT37. The relative phase detection unit 33 consists of a plurality of the relative phase detector 33(k) (k=1, 2, 3, . . . , N−1).

The reference signal generator 31 generates reference signals of N (S_{B1}, S_{B2}, . . . , S_{Bk}, . . . , S_{BN}). The reference signal generator 31 obtains information of the frequencies and the frequency intervals of the reference signals (S_{B1}, S_{B2}, . . . , S_{Bk}, . . . , S_{BN}) beforehand. These information is based on a communication technical standard. The reference signals (S_{B1}, S_{B2}, . . . , S_{Bk}, . . . , S_{BN}) do not accord with the frequency of measurement signals (S_{A1}, S_{A2}, . . . , S_{Ak}, . . . S_{AN}). However, the frequency interval of the reference signal is the same as the frequency interval Ω_{D} of the measured signal.

The beat signal processing element 32 generates the beat signal B₁, B₂, . . . , B_{N}. The beat signals (B₁, B₂, . . . , B_{N}) are generated from the measurement signals (S_{A1}, S_{A2}, . . . , S_{Ak}, . . . S_{AN}) and the reference signals (S_{B1}, S_{B2}, . . . , S_{Bk}, . . . S_{BN}). A beat signal is generated from a measurement signal and a reference signal. The two frequencies are close in mutually. And the beat signal processing element 32 selects two beat signals in a plurality of beat signals. By this selection, the redundant selection of the same beat signal is permitted. The beat signal processing element 32 generates the multiplication signal of two beat signals. And these multiplication signals are distributed to relative phase detector 33(k).

In FIG. 10, the beat signal processing element 32 comprises an arrayed-waveguide grating (AWG) 321, a PD (photodiode) group 322, a beat signal extractor 323, a signal selection circuit 324 and a mixer group 325. The arrayed-waveguide grating (AWG) 321 has two input terminals and N output terminals. The photodiode group 322 consists of N photodiodes (PD) located for an output side. The beat signal extractor 323 consists of high pass filters. Each high pass filter extracts a beat signal between a reference signal and a measurement signal from an output signal of PD group 322. The signal selection circuit 324 selects two beat signals from the output signals of beat signal extractor 323, respectively permitting repetition. The mixer group 325 consists of mixers of (N−1) units to multiply two signals in output signals of the signal selection circuit 324.

The frequency of beat signal between a reference signal and a measurement signal is Δω. The output signals of the photodiode group 322 include various kinds of beat signals other than the beat signals of frequency Δω. The beat signal extraction part 323 can extract the beat signals that frequency is Δωfrom these various kinds of beat signals.

In the signal selection circuit 324, a phase is detected as a relative phase. Thus, for example, the beat signal is not associated with the phase if the beat signal is selected like (B₁ and B₂), (B₃ and B₄), (B₅ and B₆), . . . , (B_{N-1} and B_{N}) from beat signals B₁, B₂, . . . , B_{N}.

Therefore, for example, the beat signals are selected like (B₁ and B₂), (B₂ and B₃), (B₃ and B₄), . . . , (B_{N-1}, B_{N}) “permitting repetition”. All the beat signals are associated through the phases in this way.

When a certain measurement signal S_{A(x+1)} is indefinite, the reference signal S_{B(x+1)} does not contribute to the generation of the beat signal.

As already described, in this example the information reading device 3 can receive the same measured signal many times. Thus, the signal selective circuit 324 detects the amplitude in a certain time, it can thereby know the unsettled signal beforehand. The signal selective circuit 324 can use the detection result AD with the amplitude detecting element 36 in the next time.

In the example above, signal selective circuit 324 can calculate a multiplication signal about the combination of two assumed beat signals.

The two beat signals are chosen from the beat signals B₁, B₂, B₃, . . . , B_{N} which the beat signal processor 32 generated. That is, phase cannot be detected when a one amplitude detection level of two beat signals is zero.

In this example, the original signal S_{A} (S_{A1}, S_{A2}, . . . , S_{A}k, . . . , S_{AN}) may be sent out once. In this case, the information reading device 2 can receive only one time of the same measured signal. Thus, the relative phase detection system can be provided with a delay circuit. For example, a delay circuit is provided at the appropriate position of the beat signal processor 32 (a position after PD122 to be described below). The measured signal S_{Ak}, amplitude a_{Ak} of the S_{A(k+1)}, a_{A(k+1)} can be thereby detected before than the detection of the relative phase.

The mixers of (N−1) units to comprise mixer group 325 mix two beat signals. And the multiplication signal MPL_{m/n} is sent out to the relative phase detector 33 (k) (k=1, 2, 3, . . . , N−1), respectively. Wherein the multiplication signal MPL_{m/n} is the multiplication signal of a m-th beat signal and the n-th beat signal.

Decided constant (cnstₙ-cnstₘ) is removed from DC component DC_{m/n} of multiplication signal MPL^{m/n} with relative phase detecting element 33 (k) by detection system. The constant (cnstₙ-cnstₘ) decided by the detection system is removed from DC component DC_{m/n} of the multiplication signal MPL_{m/n}. And the relative phase (φ_{An}-φ_{Am}) of two measured signals S_{Am}, S_{An} is detected. In this example, the relative phase detecting element 33 (k) detects two “relative phases in the appearance” as described in FIG. 8 (A), (B). One of “relative phases in the appearance” is identified as “true relative phase” using the signal path length modulator 34.

The amplitude detection unit 36 is comprised of the amplitude detecting element 36 (k) (k=1, 2, 3, . . . , N) of the N units. The amplitude detection unit 36 can detect the amplitude a_{Aj} of the measurement signal S_{Aj} from the amplitude of beat signal Bⱼ. The information extractor 35 stores the relative phase (φ_{An}-φ_{Am}) detected by the relative phase detection unit 33 (k), it also stores the amplitude a_{Am}, a_{An} detected by the amplitude detecting element 36. The information extractor 35 detects the signal S_{Ak}′ corresponding to the measured signal from a plurality of the relative phases and the amplitudes. Wherein, the relative phases and the amplitudes are memorized in a data storage (LUT37). And the information extractor 35 calculates ΣS_{Ak}′, and the information I included in the original signal S_{A} is read out.

In this example, the generating of the beat signals by using AWG321, the multiplication of the beat signals, the detection processing of the relative phase are possible. Also, the amplitude is detected in parallel by using AWG321, as a result high-speed operation is possible. The information I where the information extractor 35 detected can be stored LUT37 in this example. Wherein, a detected information I is linked the relative phase and the amplitude. The information extractor 35 can thereby detect the information I without calculating ΣS_{Ak}′.

Note that, in the information reading device, a key can be embedded in a value of the frequency. In this case, an encrypted information I can be embedded in original signal S_{A}.

### DENOTATION OF REFERENCE NUMERALS

1 relative phase detector
2,3 information reading device
11, 21, 31 reference signal generator
12, 22, 32 beat signal processing elements
13 detecting elements
14A, 14B, 24, 34 signal path length modulator
23, 33 (k) relative phase detecting elements
25, 35 information extraction department
26, 36 (k), 36,261,262 amplitude detecting elements
27, 37 look-up table (LUT)
33 relative phase detection unit
36 amplitude detection unit
111 discrete spectrum light source
112 drive circuits
121, 221, 1611, 1621, 2611, 2621 coupler
122, 222, 311, 1612, 1621, 2612, 2622 photodiode
123,223 band pass filters (BPF)
124,224 dividers (DV)
125,225 mixers (MX)
321 arrayed-waveguide gratings (AWG)
322 photodiode group
323 beat signal extraction part
324 signal selection circuit
325 mixer group
2614, 2624 detecting elements
1613, 1623, 2613, 2623 low pass filters (LPF)
161,162 amplitude detecting element
1614, 1624, 2614, 2624 detector

1. A relative phase detector which detects a relative phase of two measurement signals that frequencies are different using two reference signals at high-speed, the relative phase detector comprising:
a reference signal generator generating two reference signals having constant frequency difference to each of two reference signals of measurement signals,
a beat signal processor which generates a beat signal between lower frequency measurement signal and lower frequency reference signal and a beat signal between higher frequency measurement signal and higher frequency reference signal from the two measurement signals and the two reference signals, wherein the two beat signals are generated by the two measurement signals and two reference signals respectively, here after generates a square signal of the sum of the said two beat signals,
the relative phase detecting element which detects the relative phase of the two measured signals by taking out DC component from the square signal of the sum.

2. The relative phase detector comprising amplitude detecting element detecting amplitude of the two measurement signals according to claim 1, wherein the relative phase detector removes a constant decided by detection system using one or more detection results of the amplitude detecting element.

3. The relative phase detector comprising a signal path length modulator that changes at least one of signal paths length of the reference signal and the measurement signal according to claim 1, wherein in the case a relative phase between “0-π” [rad] and a relative phase between “π-2π” [rad] are detected as “relative phases in the appearances” by the relative phase detector, one of these “relative phases in the appearance” is identified as “true relative phase”,
a signal path length modulator changes the signal paths length, and the relative phase detector identifies the relative phase that changes in a right direction among two “relative phases in the appearance” as “true relative phase”.

4. A relative phase detecting method detecting a relative phase of two measurement signals that frequencies are different,
generating two reference signals having constant frequency difference to each of two measurement signals,
generating the multiplication signal of two beat signals from the two the measurement signals and the two reference signals, wherein one beat signal is generated by lower frequency measurement signal and lower frequency reference signal, and the other beat signal is generated by higher frequency measurement signal and higher frequency reference signal,
a decided constant by detection system is removed from DC component of the multiplication signal, a relative phase of two measurement signals is detected.

5. The relative phase detecting method according to claim 4 comprising the step to remove a constant decided by detection system, wherein the constant is determined using a detection result of the amplitude of the two measurement signals.

6. The relative phase detecting method according to claim 4, wherein, in the case a relative phase between “0-π” [rad] and a relative phase between “π-2π”[rad] are detected as “relative phases in the appearances”, one of these “relative phases in the appearance” is identified as “true relative phase”,
a right direction among two “relative phases in the appearance” is as “true relative phase” by changing a signal paths length.

7. An information reading device that detects a relative phase and amplitude of two measurement signals in a plurality of measurement signals included in an original signal repeatedly while changing two measurement signals, and reads information included in the original signal, comprising,
a reference signal generator generating two reference signals having a constant frequency difference to each of two measurement signals,
a beat signal processor generating a multiplication signal two beat signals, wherein one beat signal is generated by two reference signals that frequency is low and two measurement signals that frequency is low, the other beat signal is generated by two reference signals that frequency is high and two measurement signals that frequency is high,”
an amplitude detecting element detecting amplitudes two measurement signals from two beat signals, wherein one beat signal is “the beat signal generated from measurement signal that frequency is low and reference signal that frequency is low” and “the beat signal generated from measurement signal that frequency is high and reference signal that frequency is high,”
a relative phase detector detecting relative phase of two measurement signals, wherein a constant decided by detection system is removed from the DC component of the multiplication signal,
an information extractor reading information included in the original signal from a plurality of relative phases and a plurality of amplitudes, wherein a relative phase detected by the relative phase detector and the amplitude detected by the amplitude detecting element is stored sequentially.

8. The information reading device as claimed in 7 that a constant decided by detection system is removed using a detection result of the amplitude detector.

9. The information reading device as claimed in 7, wherein,
when the relative phase detector detects a relative phase between “0-π” [rad] and a relative phase between “π-2π [rad] as “relative phases in the appearances”, it identifies one of these “relative phases in the appearance” as “true relative phase”,
a signal path length modulator changes at least one of the signal path length of the signal path that the reference signal transmits or the signal path length of the signal path that the measurement signal transmits,
when the signal path length is changes by the signal path length modulator,
the relative phase detector identifies the relative phase that changes to a right direction among two “relative phases in the appearance” as “true relative phase”.

10. An information reading device that detects a relative phase and amplitude of two measurement signals in a plurality of measurement signals included in an original signal in parallel while changing two measurement signals, and reads information included in the original signal, comprising,
(a) reference signal generator,
(b) a beat signal processor (a parallel output),
(c) each a plurality of relative phase detection units comprising the relative phase detector, It is amplitude detecting element
(d) (e) information extractor,
the reference signal generator generates a plurality of reference signals which are the same as the frequency interval of the measurement signal, but the frequency is different with the frequency of the measurement signal,
the beat signal processor generates a plurality of beat signals from a plurality of measurement signals and the pair with a plurality of reference signals.

11. The relative phase detection apparatus according to claim 10 including removing constant decided by detection system using a detection result of the amplitude detector.

12. The information reading device according to claim 10:
wherein, the relative phase detecting element detects relative phase between 0-π [rad] and relative phase between π-2π [rad] as “relative phase in the appearances”, one of these two “relative phase in the appearance” is identified as “true relative phase”,
the signal path length modulator changing at least one of the signal paths length of the signal paths where the signal paths length of the signal paths where the reference signal spreads, the measured signal spread,
when it changed signal paths length by the signal path length modulator, the relative phase detecting element identifies relative phase changing into the right direction in response to the change as “true relative phase” among “the relative phase in the appearance” of two above.
